(19) United States
(12) Patent Application Publication
(10) Pub. No.: US 2025/0096706 A1
(43) Pub. Date: Mar. 20, 2025

(54) MOTOR CONTROL DEVICE, OPTICAL APPARATUS, MOTOR CONTROL METHOD, AND STORAGE MEDIUM

(71) Applicant: CANON KABUSHIKI KAISHA, Tokyo (JP)

(72) Inventor: HIROFUMI HONDA, Tokyo (JP)

(21) Appl. No.: 18/817,405

(22) Filed: Aug. 28, 2024

(30) Foreign Application Priority Data
Sep. 14, 2023 (JP) 2023-149190

(51) Int. Cl. H02P 8/18; F16H 19/04; G02B 7/02; H02K 7/06; H02K 11/215

(52) U.S. Cl. CPC H02P 8/18; G02B 7/02; H02K 7/06; H02K 11/215; F16H 19/04

(57) ABSTRACT

A motor control device includes a target position generation unit configured to generate a target position for rotation control of a motor, an encoding unit configured to detect a rotational phase of the motor and convert the rotational phase into rotation position information, an advance angle control unit configured to generate a target advance angle according to a deviation amount between the target position and the rotation position information and perform advance angle control of a drive signal, and a drive signal generation unit configured to add the target advance angle to the rotation position information to generate a drive count value and generate the drive signal based on the drive count value, in which the advance angle control unit is configured to set or calculate correction data according to the rotational phase and correct the target advance angle based on the correction data.

### BACKGROUND OF THE INVENTION

### Field of the Invention

The present invention relates to a motor control device, an optical apparatus, a motor control method, a storage medium, and the like.

### Description of the Related Art

A method in which a sensor configured to detect a rotational phase is provided in a motor and an advance angle of a drive waveform with respect to the rotational phase is controlled from the rotational phase of the motor obtained from the sensor to efficiently drive the motor has been suggested. According to this method, since control is performed such that the advance angle is optimized, it is possible to increase rotation efficiency to the maximum, and to achieve high speed or power saving.

Japanese Patent Laid-Open No. 2021-083196 has suggested a method for controlling an advance angle of a drive waveform by converting a waveform signal obtained from a rotational phase detection sensor into angle information to generate a drive count value obtained by adding a target advance angle to the angle information, and inversely converting the drive count value into a waveform signal.

Japanese Patent Laid-Open No. 2001-045780 has suggested a method for removing speed ripples by adding a sinusoidal component having a reverse phase with respect to speed ripples of a detected speed in a control device that performs PI operation on a deviation between a speed command and the detected speed to perform speed control.

Note that fluctuation may occur in the angle information detected by the rotational phase detection sensor due to rotational unevenness caused by cogging of the motor or detection accuracy of the rotational phase of the motor.

In the configuration of Japanese Patent Laid-Open No. 2021-083196, there is a problem that the fluctuation of the angle information is added to the drive count value to cause distortion in the motor drive waveform, and control ripples occur in feedback control that is performed based on the angle information. Moreover, in Japanese Patent Laid-Open No. 2001-045780, it is not possible to remove fluctuation of angle information due to factors such as cogging and detection accuracy.

### SUMMARY OF THE INVENTION

A motor control device according to an aspect of the present invention includes
at least one processor or circuit configured to function as:
a target position generation unit configured to generate a target position for rotation control of a motor,
an encoding unit configured to detect a rotational phase of the motor and convert the rotational phase into rotation position information,
an advance angle control unit configured to generate a target advance angle according to a deviation amount between the target position and the rotation position information and perform advance angle control of a drive signal, and
a drive signal generation unit configured to add the target advance angle to the rotation position information to generate a drive count value and generate the drive signal based on the drive count value,
in which the advance angle control unit is configured to
set or calculate correction data according to the rotational phase, and
correct the target advance angle based on the correction data.

Further features of the present invention will become apparent from the following description of embodiments with reference to the attached drawings.

### BRIEF DESCRIPTION OF THE DRAWINGS

FIGS. 1A and 1B are diagrams illustrating a schematic configuration of a motor unit according to a first embodiment.

FIG. 2 is a functional block diagram illustrating a configuration example of a motor control device according to the first embodiment.

FIG. 3 is a diagram illustrating a processing example of an encoding processing unit according to the first embodiment.

FIG. 4 is a diagram illustrating an example of a relationship between an advance angle and a motor rotation speed according to the first embodiment.

FIG. 5 is a flowchart illustrating a processing example of an advance angle/power rate control unit according to the first embodiment.

FIG. 6 is a flowchart illustrating a processing example of target advance angle/power rate selection processing in Step S510.

FIG. 7 is a flowchart illustrating an example of speed control by the advance angle/power rate control unit in Step S511.

FIG. 8 is a diagram illustrating a processing example of advance angle control according to the first embodiment.

FIG. 9 is a diagram illustrating an example of an influence of cogging.

FIG. 10 is a flowchart illustrating a processing example of the advance angle/power rate control unit according to the first embodiment.

FIG. 11 is a flowchart illustrating an example of drive count value correction table generation processing in Step S1001.

FIG. 12 is a diagram illustrating a processing example of drive count value correction table generation according to the first embodiment.

FIG. 13 is a flowchart illustrating a processing example of the speed control according to the first embodiment.

FIG. 14 is a flowchart subsequent to FIG. 13.

FIG. 15 is a diagram illustrating a correction processing example in the speed control according to the first embodiment.

FIG. 16 is a flowchart illustrating a processing example in speed control according to a second embodiment.

FIG. 17 is a flowchart illustrating a real-time correction processing example of Step S1600 in FIG. 16.

FIG. 18 is a flowchart subsequent to FIG. 17.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

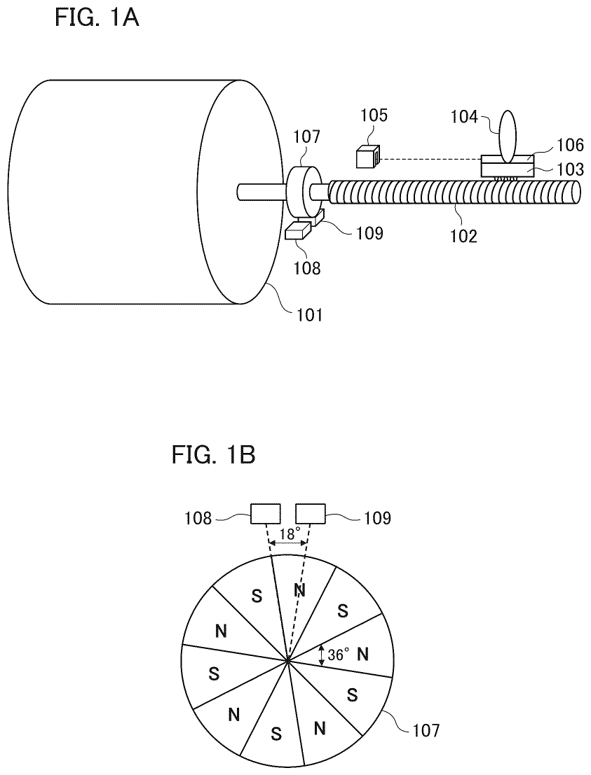

First, FIGS. 1A and 1B are diagrams illustrating a schematic configuration of a motor unit according to a first embodiment. In FIG. 1A, reference numeral 101 denotes a stepping motor, reference numeral 102 denotes a rotation shaft of the stepping motor 101, and reference numeral 103 denotes a rack.

The rotation shaft 102 is made of a lead screw, and a lens 104 serving as a moving member connected to the rack 103 moves in an axial direction according to the rotation of the rotation shaft 102 while meshing with the rack 103.

Here, a case where the motor unit illustrated in FIG. 1A is disposed inside a lens unit forming an imaging optical system, and the lens 104 is used as a moving member will be described below.

However, the motor unit is not limited to that disposed inside the lens unit. The moving member is not limited to the lens, and may be a moving member that moves according to the rotation of the motor.

If the motor unit is used to move the lens 104 inside the lens unit, this configuration is applicable to all optical apparatuses such as a lens integrated imaging apparatus and a lens interchangeable imaging apparatus. In particular, this configuration is suitable for an optical apparatus that needs to control not only a lens position after movement but also a process (movement locus) of movement like an imaging apparatus capable of capturing a video.

A reference position of the lens is determined by a configuration of a photointerrupter (PI) 105 disposed on a fixed member (not illustrated) and a light shielding plate 106 provided in the lens. The PI 105 is configured with a light emitting portion and a light receiving portion, and if the light shielding plate 106 enters between the light emitting portion and the light receiving portion with the movement of the lens 104, a detection signal of the PI 105 is switched from High to Low. This switching position is set as the reference position.

Reference numeral 107 denotes a cylindrical magnet for phase detection attached to the rotation shaft 102, and the magnet for phase detection detects a rotational phase of the stepping motor 101 in combination with Hall sensors 108 and 109. Hall signals that are outputs of the Hall sensors 108 and 109 are referred to as Hall-Ch0 and Hall-Ch1, respectively.

FIG. 1B is a diagram illustrating a disposition example of the magnet 107 for phase detection and the Hall sensors 108 and 109 for rotational phase detection in a case where the number of poles of the stepping motor 101 is ten. The magnet 107 for phase detection is configured with a ten-pole magnet in conformity with the number of poles of the motor.

The poles are disposed uniformly over mechanical angles of 36°. The Hall sensors 108 and 109 for rotational phase detection are disposed on extension lines of a mechanical angle of 18 degrees of the magnet 107 for phase detection. With this configuration, two kinds of sinusoidal waves having phases deviated from each other by 90° according to the rotation of the motor are detected from the Hall sensors. That is, a pair of Hall sensors 108 and 109 is disposed such that sinusoidal waveforms having phases deviated from each other by 90° are detected.

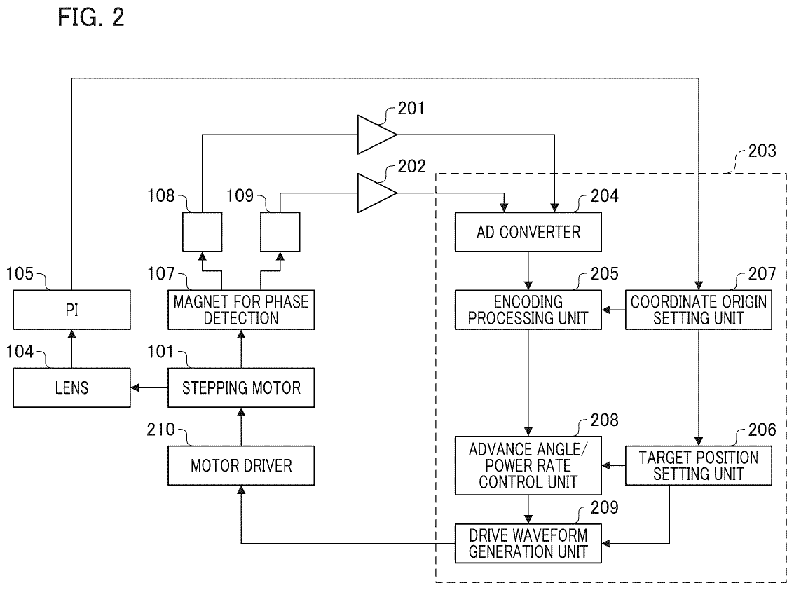

Next, FIG. 2 is a functional block diagram illustrating a configuration example of the motor control device according to the first embodiment. Some of functional blocks illustrated in FIG. 2 are implemented by a CPU or the like serving as a computer (not illustrated) included in the motor control device executing a computer program stored in a memory serving as a storage medium (not illustrated).

Note that some or all of the functional blocks may be implemented by hardware. As hardware, a dedicated circuit (ASIC), a processor (a reconfigurable processor or a DSP), or the like can be used. Moreover, the respective functional blocks illustrated in FIG. 2 may not be built into the same housing or may be configured with separate devices connected via signal paths.

A stepping motor 101, a lens 104, a PI 105 for reference position detection, a magnet 107, and Hall sensors 108 and 109 are the same as those described with reference to FIGS. 1A and 1B.

Two-phase Hall signals Hall-Ch0 and Hall-Ch1 detected by the Hall sensors 108 and 109 are amplified by amplification circuits 201 and 202, respectively. The amplified two-phase Hall signals are quantized at an AD converter 204 of a signal processing unit 203, and are subjected to encoding processing by an encoding processing unit 205. In this way, a position detection count value is calculated.

Here, the encoding processing unit 205 functions as an encoding unit configured to execute an encoding step of detecting the rotational phase of the motor and converting the rotational phase into rotation position information.

Reference numeral 206 denotes a target position setting unit that sets a target position of the lens, and the target position setting unit generates a target position count value for controlling the lens to have a target speed at a target position. The target position setting unit 206 functions as a target position generation unit configured to execute a target position generation step of generating the target position for rotation control of the motor. For the position detection count value and the target position count value, the same coordinate origin is set at a coordinate origin setting unit 207, and coordinates are aligned.

Reference numeral 208 denotes an advance angle/power rate control unit, and the advance angle/power rate control unit sets a target advance angle and adds the target advance angle to the position detection count value to generate a drive count value. Moreover, the advance angle/power rate control unit 208 performs feedback control of an advance angle and an amplitude of a drive waveform by setting a power rate such that the lens moves while following the target position count value.

Moreover, the advance angle/power rate control unit 208 functions as an advance angle control unit configured to execute an advance angle control step of generating a target advance angle according to a deviation amount between the target position and the rotation position information and performs advance angle control of a drive signal. In the present embodiment, the advance angle/power rate control unit 208 has a function of setting or calculating correction data according to the rotational phase and correcting the target advance angle based on the correction data.

The drive count value is subjected to SIN/COS conversion in a drive waveform generation unit 209, and two-phase drive waveforms whose amplitudes are adjusted according to a power rate are generated. The drive waveform generation unit 209 functions as a drive signal generation unit configured to execute a drive signal generation step of superimposing the target advance angle on the rotation position information to generate the drive count value and generating the drive signal based on the drive count value.

Note that, since the feedback control cannot be performed until the coordinate origin is set at the coordinate origin setting unit 207, open control is performed during this duration. In this case, the advance angle/power rate control unit 208 sets the target position count value obtained from the target position setting unit 206 as the drive count value and sets a power rate for open control to control a drive waveform.

The generated drive waveforms are converted into motor drive signals at a motor driver 210, and the motor drive signals are supplied to the stepping motor 101. While the drive waveforms are converted into PWM signals and the PWM signals are supplied to the motor driver 210, the drive waveforms may be subjected to AD conversion processing and supplied or may be supplied as drive waveform information from a communication port.

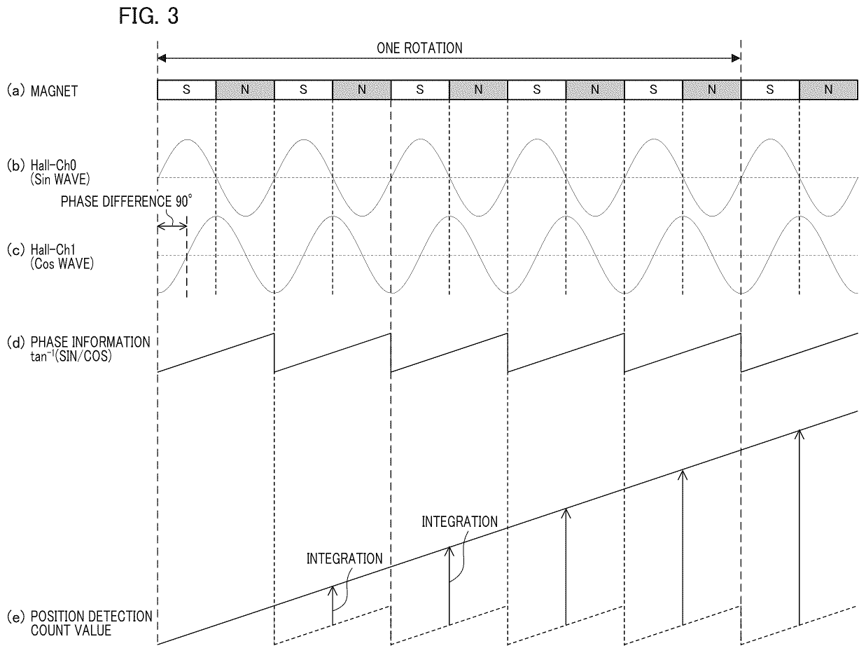

Here, details of processing of the encoding processing unit 205 will be described with reference to FIG. 3. FIG. 3 is a diagram illustrating a processing example of the encoding processing unit according to the first embodiment. Here, description will be provided assuming that the number of poles of the stepping motor 101 is ten in conformity with the configuration of the FIG. 1B, and the magnet 107 for phase detection is a ten-pole cylindrical magnet in conformity with the number of poles of the stepping motor 101.

In FIG. 3, (a) indicates the magnet 107 for phase detection of the motor, and (b) and (c) represent waveforms of Hall signals Hall-Ch0 and Hall-Ch1 obtained in respective rotational phases. The Hall sensors 108 and 109 are disposed at the positions as illustrated in FIG. 1B, and the waveforms of the Hall signals are two kinds of sinusoidal waves having phases deviated from each other by 90°.

Since the two-phase sinusoidal waves have the phases deviated from each other by 90°, the two kinds of sinusoidal waves (b) and (c) have a relationship of Sin and Cos. The encoding processing unit 205 performs an arctangent operation (tan−1(Sin/Cos)) from the signals (b) and (c) of Sin and Cos quantized by the AD converter 204 and calculates phase information (d) of 0 to 360°.

Moreover, the encoding processing unit 205 integrates the calculated phase information (d) to calculate a motor rotation amount. The rotation position information that is convertible into position information of the lens is acquired by multiplying the rotation amount information by a screw pitch of the lead screw. That is, the rotation position information in the present embodiment is information regarding a rotation amount obtained by integrating the rotational phase calculated based on the signals from a pair of the Hall sensors according to the rotation of the motor.

Accordingly, the rotation amount information of the motor calculated by the encoding processing unit 205 is handled as a position detection count value (e) of the lens. Here, while the phase information has been described as information of 0 to 360°, the phase information is determined by the resolution of the position detection count value, and is not limited thereto.

Next, the processing of the coordinate origin setting unit 207 will be described in detail. The signal processing unit 203 first executes a setting sequence of the coordinate origin of the lens upon power-on. That is, the lens is driven, and a lens position where the detection signal of the PI 105 described with reference to FIGS. 1A and 1B is switched from High to Low is searched for. That is, the motor is driven and the coordinate origin of the position of the moving member is searched for.

Then, with the found switching position as the coordinate origin, and the position detection count value and the target position count value are initialized to prescribed values. That is, initialization drive for initializing the target position and the rotation position information to prescribed values with the found position as a reference and aligning coordinates is performed. Accordingly, the coordinates of both the target position and the rotation position information are aligned, and the control of the lens position can be performed.

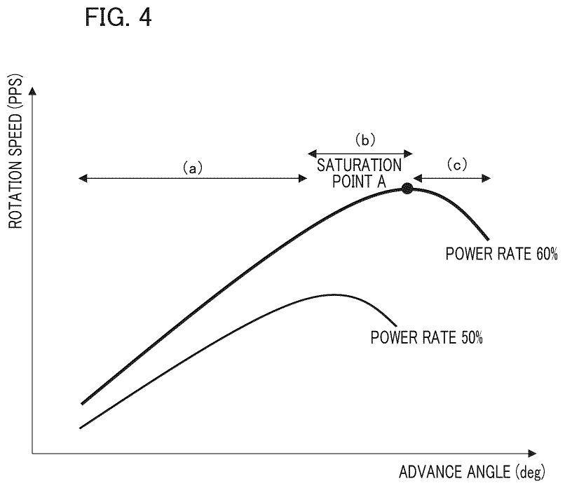

The processing of the advance angle/power rate control unit 208 will be described in detail with reference to FIGS. 4 to 7. First, FIG. 4 is a diagram illustrating an example of a relationship between an advance angle and a motor rotation speed according to the first embodiment. In FIG. 4, the relationship between the advance angle and the motor rotation speed is illustrated in a form of a waveform at power rates of 60% and 50% as an example.

The power rate adjusts the amplitude of the drive waveform, and for example, the power rate of 60% means that a waveform is formed to limit the amplitude of the drive waveform to 60%. In the waveform of the power rate of 60% of FIG. 4, the motor rotation speed increases in proportion as the advance angle increases in an area (a).

Note that, if the advance angle further increases, the motor rotation speed reaches an area (b) where an increase in the motor rotation speed with respect to the advance angle is gradually saturated, soon. Then, if the advance angle further increases, the motor rotation speed enters an area (c) where the motor rotation speed slows down with a saturation point A as a boundary.

As the power rate is greater, a gradient of the motor rotation speed with respect to advance angle in the area (a) is steeper, and as the power rate is greater, the saturation point A is shifted toward the greater advance angle. The advance angle and the speed have a relationship proportional within a range of the area (a). That is, if γ is the gradient of the motor rotation speed with respect to the advance angle, and β is an offset, the relationship between the advance angle and the speed can be expressed by Expression 1 below.

$$Speed = Advance angle * γ + β \qquad ( 1 )$$

Therefore, the relationship between the advance angle and the rotation speed is measured in advance, and the gradient γ and the offset β of Expression 1, and an effective area W of Expression 1 corresponding to the area (a) are stored as an advance angle/speed table based on measurement data.

It is assumed that a plurality of advance angle/speed tables are stored for each power rate, and can be selected according to a target speed. In this case, it is assumed that the smaller power rate is selected with priority.

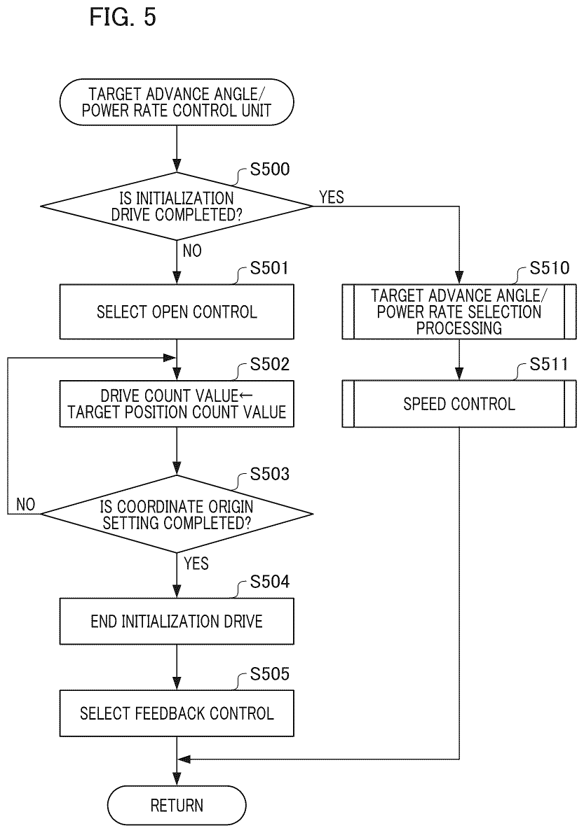

FIG. 5 is a flowchart illustrating a processing example of the advance angle/power rate control unit according to the first embodiment. The processing of the advance angle/power rate control unit 208 will be described with reference to the flowchart of FIG. 5.

The operations in respective steps of the flowchart of FIG. 5 are sequentially performed by the CPU or the like serving as a computer in the motor control device executing a computer program stored in the memory.

As described above in the description of FIG. 2, in regard to the position detection count value and the target position count value, the same coordinate origin is set at the coordinate origin setting unit 207, and the coordinates are aligned. Note that, since the feedback control cannot be performed until the coordinate origin is set at the coordinate origin setting unit 207, the open control is performed during the duration.

Therefore, the advance angle/power rate control unit 208 performs the open control during the duration of the initialization drive and switches a control method to the feedback control after the initialization drive is completed. Determination about switching is performed in Step S500, and if determination is not made that the initialization drive is completed, the process proceeds to Step S501 and the processing of the initialization drive is executed.

In the processing of the initialization drive, the open control is selected in Step S501, and the target position count value is set as the drive count value in Step S502. That is, during the duration of the initialization drive, control is switched such that the advance angle control is not performed, the target position is set to the drive count value, and the open control is performed. Next, in Step S503, the processing of Steps S502 and S503 is repeated until the completion of the setting of the coordinate origin in the coordinate origin setting unit 207 is detected.

If the setting of the coordinate origin is completed, the process proceeds to Steps S504 and S505, and after the initialization drive is completed, the process returns to Step S500. Thereafter, the process proceeds to Step S510, and the process is switched to the feedback control. That is, if the initialization drive ends, control is switched to the advance angle control. Then, target advance angle/power rate selection processing is executed, and speed control is performed in Step S511.

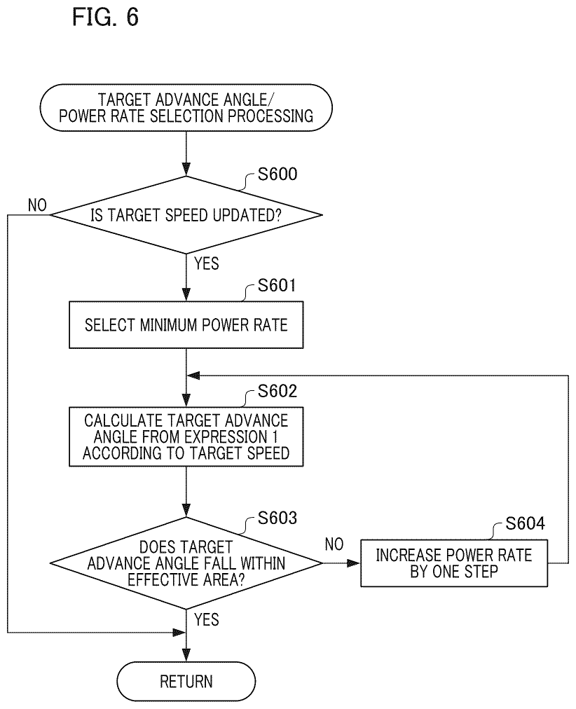

FIG. 6 is a flowchart illustrating a processing example of the target advance angle/power rate selection processing in Step S510. The operations in respective steps of the flowchart of FIG. 6 are sequentially performed by the CPU or the like serving as a computer in the motor control device executing a computer program stored in the memory.

The advance angle/power rate control unit 208 first determines in Step S600 whether or not the target speed is updated. If the target speed is updated, the process proceeds to Step S601, and a lowest power rate is selected. In Step S602, the advance angle/speed table and the target speed corresponding to the selected power rate are referred to, and the target advance angle is calculated using Expression 1 described above.

Next, in Step S603, determination is made whether or not the calculated target advance angle falls within a range of the effective area W. If determination is made that the target advance angle falls within the range of the effective area W, the process returns to Step S600, and the flow of FIG. 6 is repeated. In Step S603, if determination is made that the target advance angle is out of the range of the effective area W, the process proceeds to Step S604, the power rate increases by one step, and the process returns to Step S602.

The processing of Steps S602 to S604 is repeated until determination is made that the target advance angle is within the range of the effective area W. The target speed is calculated from a deviation amount (l) between a current position and the target position and a target time (t) required for movement to the target position by Expression 2 below.

$$Target speed = Deviation amount ( l ) / Target time ( t ) \qquad ( 2 )$$

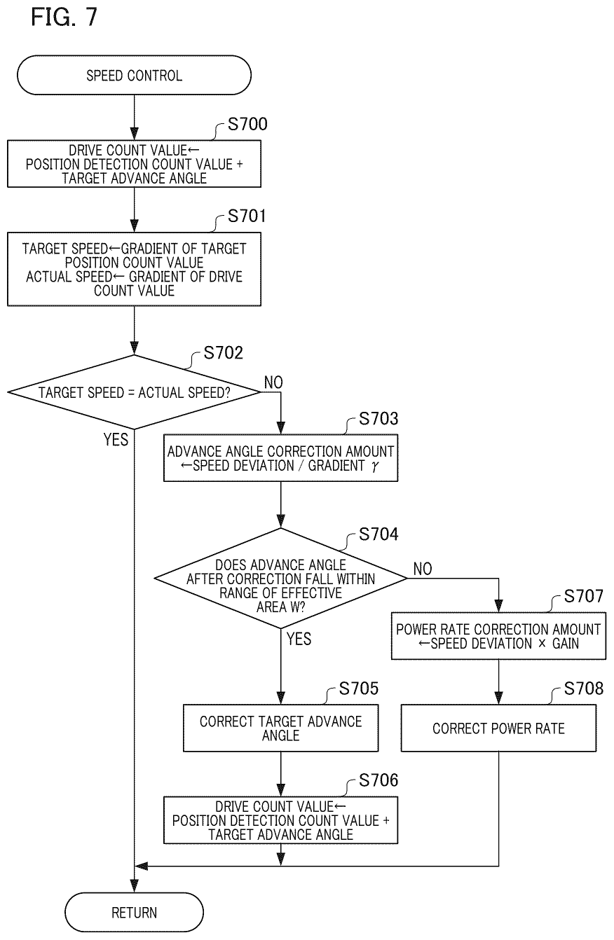

Next, FIG. 7 is a flowchart illustrating an example of the speed control by the advance angle/power rate control unit in Step S511. The operations in respective steps of the flowchart of FIG. 7 are sequentially performed by the CPU or the like serving as a computer in the motor control device executing a computer program stored in the memory.

In the flow of FIG. 7, the feedback control of the advance angle and the power rate of the drive waveform is performed using the target advance angle and the power rate selected in the target advance angle/power rate selection processing of Step S510 (the flow of FIG. 6).

First, in Step S700, the drive count value obtained by adding the target advance angle to the position detection count value is generated. Next, in Step S701, the target speed is calculated from a gradient of the target position count value, and an actual speed is calculated from a gradient of the drive count value.

Here, Step S701 functions as a target speed calculation unit configured to calculate a gradient of the target position set by the target position generation unit as the target speed. Moreover, Step S701 also functions as a detected speed calculation unit configured to calculate a gradient of the rotation position information changing according to the rotation of the motor as a detected speed (actual speed).

In Step S702, determination is made whether or not the calculated target speed is equal to the actual speed, and if determination is made to be Yes, the process returns to Step S700. If determination is made to be No in Step S702, the process proceeds to Step S703, and an advance angle correction amount is calculated. Here, the advance angle correction amount is calculated from the relational expression between the advance angle and the speed of Expression 1 by Expression 3 below.

$$Advance angle correction amount = Speed deviation amount / Inclination γ \qquad ( 3 )$$

In this way, the deviation amount between the target position and the rotation position information is converted into the speed deviation amount between the target speed and the detected speed, and an adjustment amount (advance angle correction amount) of the advance angle is calculated based on the converted speed deviation amount. Note that an advance angle amount needs to be limited within the range of the area (a) of FIG. 4.

Accordingly, in Step S704, determination is made whether or not the advance angle amount after correction falls within the range of the effective area W. If determination is made to be Yes, the process proceeds to Step S705, and the target advance angle is corrected based on the adjustment amount calculated in Step S703.

In Step S706, the re-generation of the drive count value is performed according to the correction of the target advance angle. That is, similarly to Step S700, the drive count value obtained by adding the target advance angle to the position detection count value is generated, and thereafter, the process returns to Step S700. On the other hand, in Step S704, if determination is made to be No, that is, if determination is made that the advance angle amount after correction is out of the range of the effective area W, the process proceeds to Step S707, and a correction amount of the power rate (the amplitude of the drive signal) is calculated.

The correction amount of the power rate is calculated by multiplying the speed deviation amount by a prescribed gain (proportional gain, integral gain, derivative gain, or the like). Then, in Step S708, the power rate is corrected based on a calculated result. That is, the amplitude (power rate) of the drive signal is adjusted according to the speed deviation amount between the target speed and the detected speed. Thereafter, the process proceeds to Step S700.

With the processing of the flow of FIG. 7 as above, the target advance angle and the power rate are controlled. As a result, speed feedback for following the target position count value can be implemented.

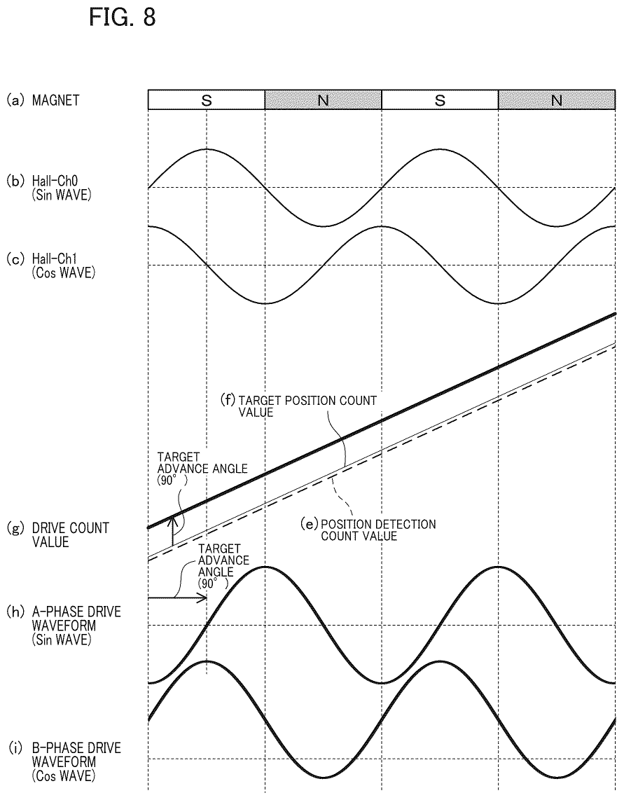

Next, a flow of the processing of the advance angle control will be described in detail with reference to FIG. 8. FIG. 8 is a diagram illustrating a processing example of the advance angle control according to the first embodiment.

Since (a), (b), (c), and (e) in FIG. 8 are the same as signals described with the same reference numerals of FIG. 3, description thereof will not be repeated. (f) indicates the target position count value. As described above, the target advance angle and the power rate are calculated such that the position detection count value (e) follows the target position count value (f).

Here, description will be provided with a case where the target advance angle is 90°, as an example. Like Step S700, the advance angle/power rate control unit 208 adds the target advance angle of 90° to the position detection count value to generate a drive count value (g). That is, the drive count value is angle information generated by superimposing the target advance angle on the position detection count value (e).

The position detection count value (e) is a count value obtained by integrating the phase information (d) of 0 to 360°, and similarly, the drive count value (g) also has 0 to 360° below the count value as phase information.

Accordingly, in the drive waveform generation unit 209, two-phase drive waveforms SIN wave (h) and COS wave (i) having phases deviated by an amount for the advance angle with respect to the rotational phase of the motor by subjecting the drive count value (g) to SIN conversion and COS conversion are generated. That is, sinusoidal two-phase drive signals having phases deviated from each other by 90° are generated by converting the angle information of the drive count value by the drive waveform generation unit 209 serving as a drive signal generation unit.

The power rate is set such that the drive waveforms have a target amplitude, and is output to the motor driver 210. Here, while the phase information (d) has been described as information of 0 to 360°, the phase information is determined by the resolution of the position detection count value (e), and is not limited thereto.

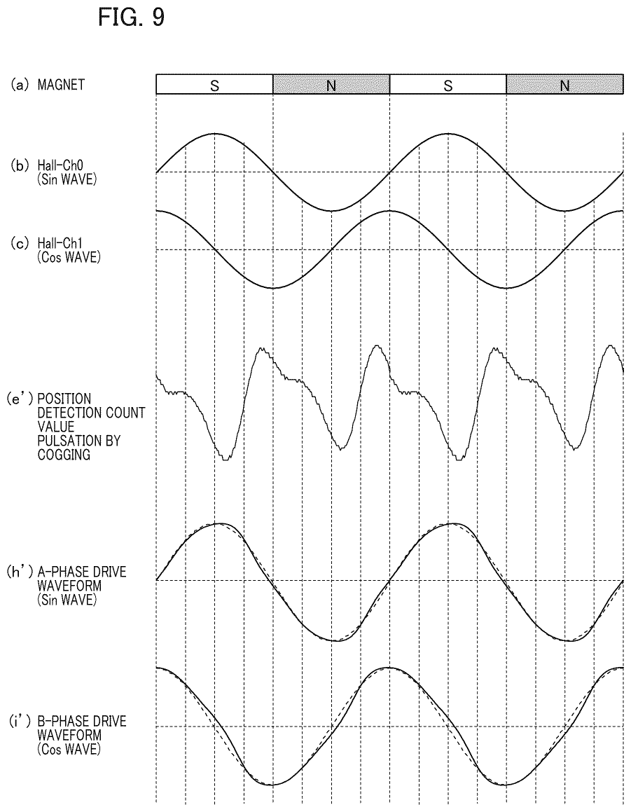

A phenomenon (hereinafter, referring to cogging) in which deviation of the magnetic flux distribution of a permanent magnet that is a rotor of the motor causes pulsation of magnetic attracting force is generated. FIG. 9 is a diagram illustrating an example of an influence of cogging. In FIG. 9, (e′) indicates a state in which the position detection count value fluctuates due to rotational unevenness caused by cogging.

The fluctuation of the position detection count value (e′) due to cogging varies in synchronization with the motor rotational phase. That is, the rotation position information has periodic fluctuation according to the rotation of the motor, and the fluctuation is synchronized with the phases of the two-phase signals detected from the Hall sensors.

As described above, since the drive count value (g) is generated by superimposing the target advance angle on the position detection count value, a cogging component is also added to the drive count value. If there is fluctuation of the drive count value, it is not possible to accurately obtain the actual speed that is obtained from the gradient of the drive count value, and the responsibility of the speed control or followability to the target position is influenced.

The drive waveforms that are generated by the drive waveform generation unit 209 in a state in which fluctuation occurs in the drive count value are as solid lines (h′) and (i′), for example. That is, distortion with respect to ideal SIN wave and COS wave indicated by broken lines occurs, and the distortion of the drive waveforms becomes a factor for vibration or noise.

For this reason, in the present embodiment, the fluctuation of the drive count value due to cogging to be the factor is corrected. The fluctuation of the position detection count value also occurs due to a mechanical factor such as magnetization unevenness of the magnet 107 for phase detection, the shake of the rotation shaft 102 on which the magnet 107 for phase detection is mounted, or deviation of attachment positions of the Hall sensors 108 and 109. Here, description will be provided with the fluctuation of the position detection count value due to cogging as an example.

Here, the processing of the target advance angle/power rate control unit 208, which is the feature of the first embodiment, for implementing the correction of the fluctuation of the drive count value as the feature of the first embodiment will be described below.

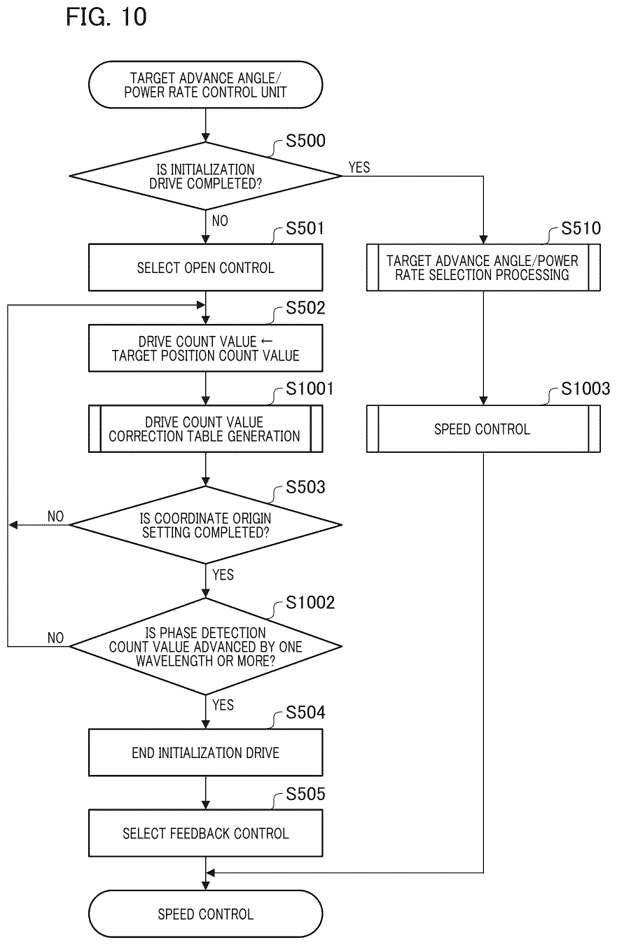

FIG. 10 is a flowchart illustrating a processing example of the advance angle/power rate control unit according to the first embodiment, and illustrates a flow of generation of a correction table and correction using the correction table in the target advance angle/power rate control unit 208.

The operations in respective steps of the flowchart of FIG. 10 are sequentially performed by the CPU or the like serving as a computer in the motor control device executing a computer program stored in the memory. Similar processing to the processing described with reference to FIG. 5 will be described using the same reference numerals.

As described above, the advance angle/power rate control unit 208 performs the open control during the initialization drive and switches the control method to the feedback control after the initialization drive is completed. Determination about switching is performed in Step S500, and here, until determination is made that the initialization drive is completed, the process proceeds to Step S501 and the processing of the initialization drive is performed.

In the processing of the initialization drive, the open control is selected in Step S501, and the target position count value is set as the drive count value in Step S502. Here, processing of Step S1001 is added in the flow illustrated in FIG. 10, and the correction table of the drive count value is generated in Step S1001.

The correction table is created for one wavelength of the detected signals (b) and (c) of the Hall sensors 108 and 109. Accordingly, if determination is made in Step S503 that the setting of the coordinate origin is completed, in Step S1002, determination is made that the position detection count value (e) is advanced for one wavelength of 0 to 360° or more. If determination is made to be Yes in Step S1002, the initialization drive is completed in Step S504.

On the other hand, if determination is made to be No in Step S503 or S1002, the process returns to Step S502, and the setting of the coordinate origin and the generation of the correction table are repeatedly performed. On the other hand, if determination is made in Steps S503 and S1002 that the setting of the coordinate origin and the generation of the correction table are completed, respectively, the process proceeds to Steps S504 and S505, and the process is switched to the feedback control along with the completion of the initialization drive.

After the initialization drive is completed, the process returns to Step S500, determination is made to be Yes in Step S500, the process proceeds to Step S510, and the target advance angle/power rate selection processing is executed. In addition, in Step S1003, setting of advance angle count value correction data and speed control are performed. In the present embodiment, the correction data is the correction table stored in the memory in advance.

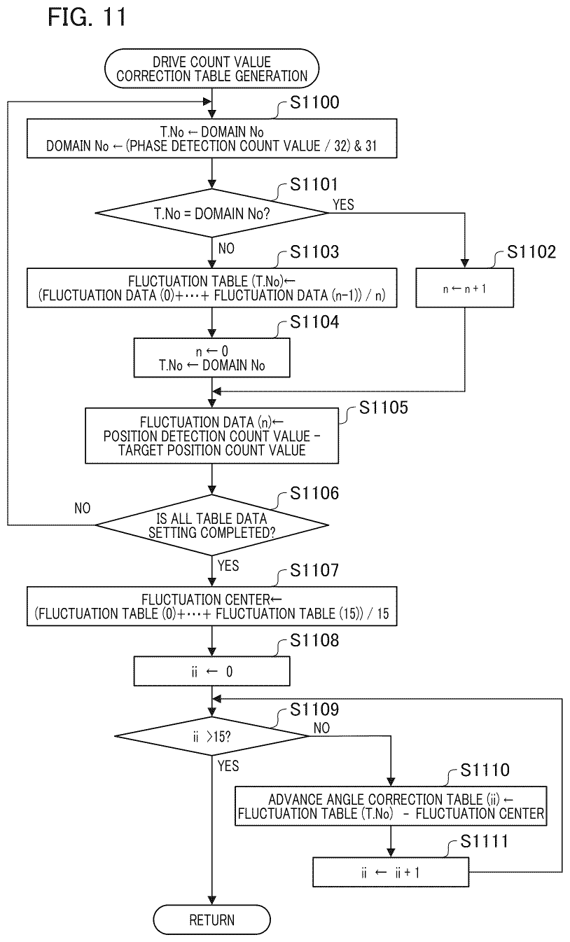

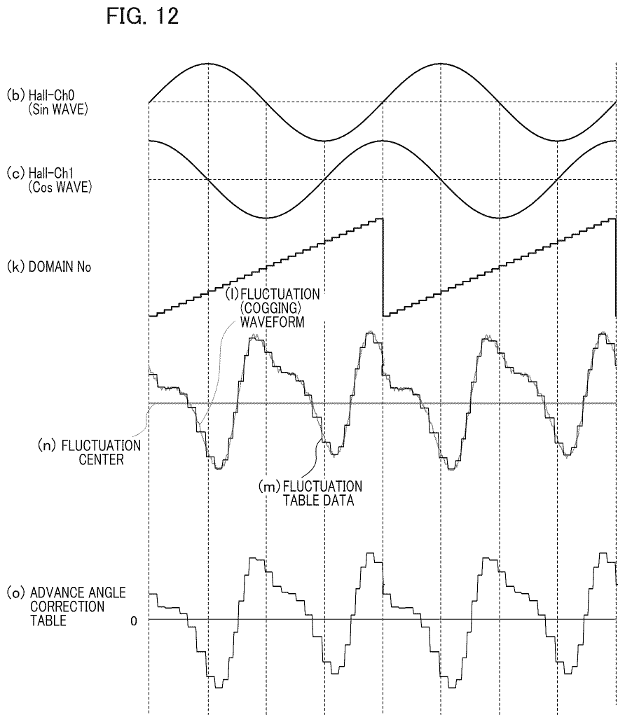

Here, drive count value correction table generation processing of Step S1001 will be described with reference to a flowchart of FIG. 11 and a relationship diagram of FIG. 12.

FIG. 11 is a flowchart illustrating an example of drive count value correction table generation processing in Step S1001. The operations in respective steps of the flowchart of FIG. 11 are sequentially performed by the CPU or the like serving as a computer in the motor control device executing a computer program stored in the memory.

In the flow of FIG. 11, first, after a domain No is set as a table No (T.No) in S1100, the domain No is updated. Here, the domain No indicates an area No when the phases of detected waveforms of the Hall sensors 108 and 109 for rotational phase detection are divided into a plurality of phase areas. Here, an example where the phase of the detected waveform is divided into 32 areas at 11.25° will be described. That is, a phase range for one period of the periodic fluctuation is divided into a plurality of areas.

The domain No can be obtained from Expression 4 below.

$$Domain No = ( position detection count value / 32 ) \& 31 \qquad ( 4 )$$

If the domain No and T.No do not match in Step S1101, the process proceeds to Step S1103, and if the domain No and T.No match, the process proceeds to Step S1102. In Step S1102, n is incremented by one, and subsequently, in Step S1105, fluctuation data (n) is calculated.

The fluctuation data (n) indicates fluctuation of the position detection count value (e) herein, and as described with reference to FIG. 9, the fluctuation is transmitted to the drive count value (g) at it is.

By measuring a deviation amount between the position detection count value (e) and the target position count value (f), a gradient component of the position detection count value is removed, and only a fluctuation component can be extracted. That is, a fluctuation amount of fluctuation is measured from a difference between the target position and the rotation position information.

Until the domain No calculated in Step S1100 is updated to a value different from T.No (table No) that is a backup of the domain No, the processing of Steps S1102 and S1105 is repeatedly executed.

In Step S1101, if determination is made that the domain No is updated to a value different from T.No (table No), the process proceeds to Step S1103, and here, an average value of fluctuation data in the same domain is set as a fluctuation table (T.No).

Next, in Step S1104, a count value n of the same domain is cleared, and T.No is updated with the domain No. The processing of Steps S1100 to S1105 is repeatedly executed until determination is made in Step S1106 that fluctuation data of all tables is set.

If determination is made in Step S1106 that the setting of all of table data is completed, the process proceeds to Step S1107, and an average value of fluctuation data of all tables is obtained. That is, a central value of the fluctuation is measured. Then, the central value is set as a fluctuation center.

Next, in Steps S1108 to S1111, an advance angle correction table obtained by subtracting fluctuation data of each table from the fluctuation center is measured, and this operation is repeated by the number of tables, and the process ends.

That is, in Step S1108, ii of an advance angle correction table (ii) is set to 0, in Step S1109, determination is made whether or not ii>15, and if determination is made to be Yes in Step S1109, the process returns to Step S1100.

On the other hand, if determination is made to be No in Step S1109, the process proceeds to Step S1110, and the advance angle correction table (ii) is set to a difference value between the fluctuation table (T.No) and the fluctuation center. That is, the correction data is calculated from the difference between the fluctuation amount and the central value of the fluctuation. Thereafter, the process returns to Step S1109. In this way, in the present embodiment, the phase range for one period is divided into a plurality of areas, and the correction data according to the rotational phase is set for each area.

FIG. 12 is a diagram illustrating a processing example of drive count value correction table generation according to the first embodiment, and illustrates a relationship of drive waveforms, a domain No, fluctuation data, a fluctuation table, and an advance angle correction table.

The domain No generated in Step S1102 is indicated by (k) of FIG. 12, is counted up for each phase of 11.25° of the drive waveforms (h) and (i), and becomes a count value No of 0 to 31 (0 to 360° of the drive waveforms).

(l) indicated by a light line indicates fluctuation data of the fluctuation waveform calculated in Step S1105, and (m) is fluctuation table data. As the fluctuation table data, an average value of the fluctuation data in each domain is set. (n) of FIG. 12 is the fluctuation center calculated in Step S1107 and is obtained from an average value of the fluctuation table data. (o) of FIG. 12 indicates data of the advance angle correction table set in Step S1110.

Subsequently, correction processing of the drive count value will be described. Target advance angle/power rate selection processing in Step S510 of FIG. 10 is equivalent to the processing described with reference to FIG. 6, and description thereof will be omitted.

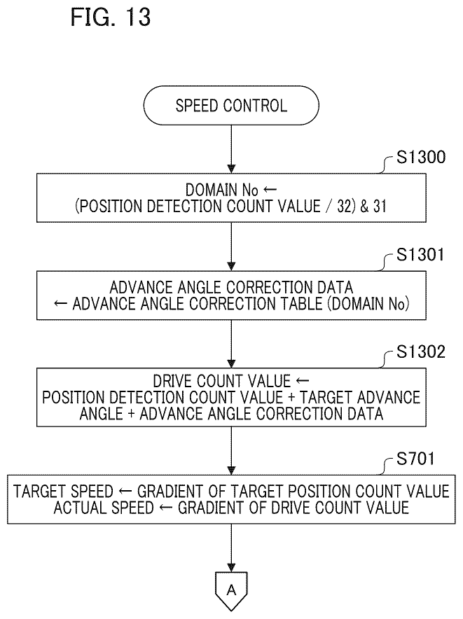

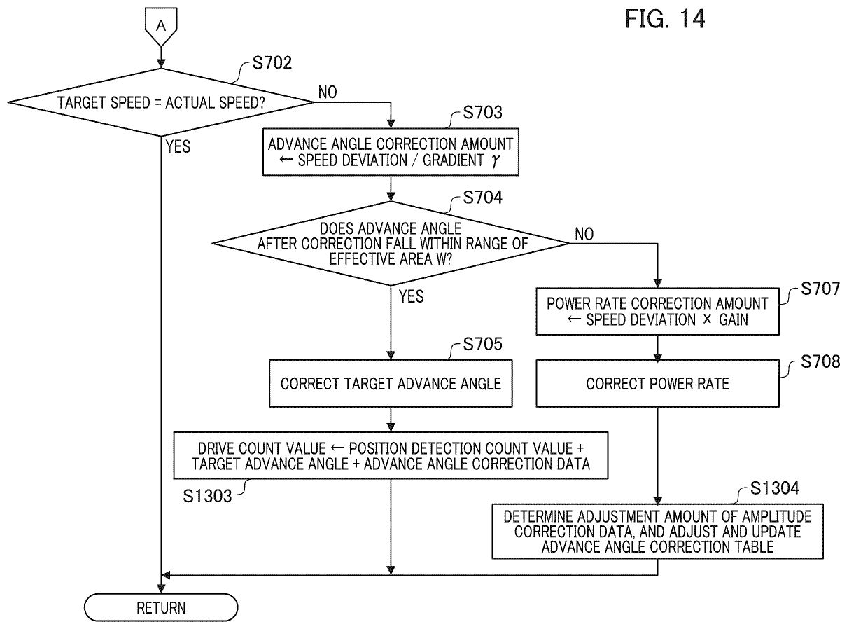

The processing of the speed control in Step S1003 of FIG. 10 will be described using a flowchart of FIG. 13. FIG. 13 is a flowchart illustrating a processing example of the speed control according to the first embodiment, and FIG. 14 is a flowchart subsequent to FIG. 13. The operations in respective steps of the flowcharts of FIGS. 13 and 14 are sequentially performed by the CPU or the like serving as a computer in the motor control device executing a computer program stored in the memory.

In FIG. 13, first, the domain No (k) indicating the phase of the current drive waveform is calculated in Step S1300. A calculation method is as described in Step S1100. Next, in Step S1301, advance angle correction data in the phase (domain No) of the current drive waveform is acquired from the advance angle correction table data (o) generated in Step S1001 of FIG. 10 as in FIG. 12.

Subsequently, in Step S1302, the drive count value (g) is generated. Here, in the generation of the drive count value (g) in the first embodiment, the target advance angle is added to the position detection count value (e), and the advance angle correction table data (o) is further added. Accordingly, the drive count value (g) corrected to remove a fluctuation component of the position detection count value (e) due to cogging is generated.

In Step S701, the target speed is calculated from the gradient of the target position count value (f). Moreover, the actual speed is calculated from the gradient of the drive count value (g). In this way, since the drive count value (g) has a corrected fluctuation component, it is possible to obtain the accurate actual speed with suppressed influence of the fluctuation.

Subsequently, as illustrated in FIG. 13, in Step S702, the target speed and the actual speed calculated in the above-described manner are compared, and if the target speed and the actual speed are equal, the process returns to Step S1300. If determination is made in Step S702 that there is a speed deviation, the process proceeds to Step S703, and the advance angle correction amount is calculated.

Here, the advance angle correction amount can be obtained from Expression 3 described above. Note that, since the advance angle amount needs to be limited within the area (a), if determination is made in Step S704 that the advance angle amount after correction falls within the range of the effective area W, the process proceeds to Step S705, and the correction of the target advance angle is performed.

In Step S1303, the re-generation of the drive count value (g) is performed according to the correction of the target advance angle. That is, similarly to Step S1302, the target advance angle is added to the position detection count value (e), and the advance angle correction table data (o) is further added. Accordingly, the drive count value (g) corrected to remove the fluctuation component of the position detection count value (e) due to cogging is generated. After the processing of Step S1303, the process returns to Step S1300.

On the other hand, if determination is made in Step S704 that the advance angle amount after correction is out of the range of the effective area W, the process proceeds to Step S707, and the power rate correction amount is calculated. The power rate correction amount is calculated by multiplying the speed deviation amount by a prescribed gain (proportional gain, integral gain, derivative gain, or the like). In Step S708, the power rate is corrected using the power rate correction amount calculated in Step S707.

Moreover, if a drive amplitude increases, a fluctuation width of cogging also increases. Thus, a relationship between the drive amplitude and the fluctuation width of cogging is measured, and an adjustment parameter of amplitude correction data is set from a measurement result. That is, the advance angle control unit has a parameter indicating the relationship between the amplitude of the drive signal and the fluctuation width.

Then, in Step S1304, an adjustment amount of the amplitude correction data is determined based on the adjustment parameter according to the power rate, and the advance angle correction table data (o) is adjusted and updated. That is, a correction width is adjusted according to the amplitude of the drive signal. After the processing of Step S1304, the process returns to Step S1300.

The fluctuation of the position detection count value due to cogging has been described above. As described above, the fluctuation of the position detection count value also occurs due to a mechanical factor of a constituent portion detecting the rotational phase of the motor.

In this case, a period of the fluctuation of the position detection count value is synchronized with a rotation period of the motor. Therefore, for the domain No, instead of the waveform period of the Hall sensors 108 and 109 for rotational phase detection, the rotational phase of the motor is divided to set the phase area.

Moreover, a fluctuation pattern of the drive count value changes depending on a rotation direction of the motor. For this reason, the advance angle correction table (o) is prepared on each of forward and reverse rotations. That is, the correction data is set respectively according to the rotation direction of the motor. In addition, the fluctuation pattern of the drive count value also changes depending on a rotation speed of the motor. For this reason, it is desirable that the advance angle correction table (o) is set at a plurality of speeds.

If the advance angle correction table (o) is provided at a plurality of speeds, correction data of a speed to be a target can be obtained by interpolation using correction data of speeds at two points with the speed to be the target sandwiched therebetween. That is, if the target speed at which correction data is not set is selected, the correction data can be calculated by interpolation.

In the present embodiment, while the generation of the advance angle correction table (o) is carried out in the duration of the initialization drive, if an occurrence pattern of cogging is unlikely to be changed due to a lapse of time or a temperature, a predetermined value may be employed. Alternatively, the generation of the advance angle correction table (o) may be carried out in a process.

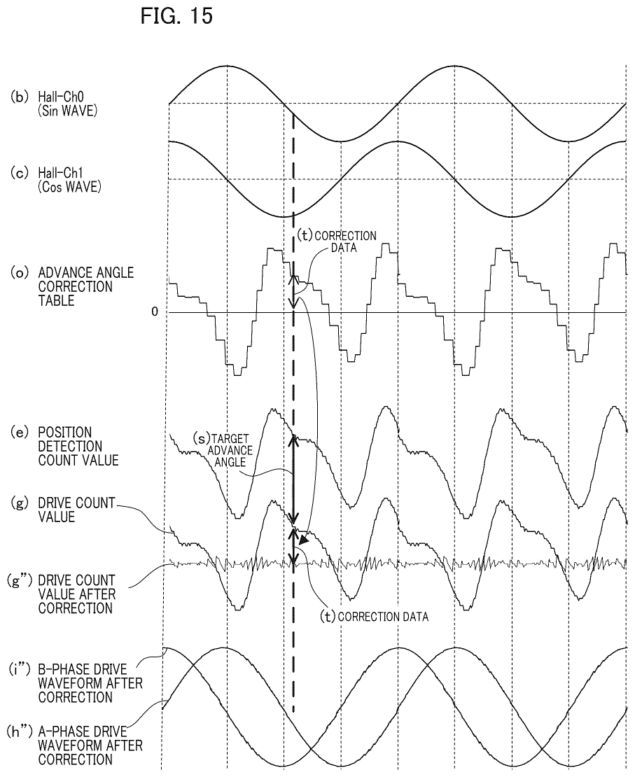

Next, FIG. 15 is a diagram illustrating a correction processing example in the speed control according to the first embodiment, and illustrates a relationship of drive waveforms, an advance angle correction table (o), a position detection count value (e), a drive count value (g), and a drive count value (g″) after correction.

In the position detection count value (e) generated by the encoding processing unit 205, fluctuation occurs due to cogging. If there is no correction, a target advance angle(s) is added to the position detection count value (e) to generate the drive count value (g).

On the other hand, in Step S1302, the target advance angle(s) is added to the position detection count value (e), and correction data (t) of the advance angle correction table (o) is further added. Accordingly, since the drive count value generated in Step S1302 has a considerably corrected fluctuation component like (g″), it is possible to obtain the accurate actual speed while avoiding the influence of the fluctuation.

Therefore, an influence on the responsibility of the speed control or followability to the target position is avoided. In addition, with the correction of the drive count value, the drive waveforms generated by the drive waveform generation unit 209 become (h″) and (i″), and it is understood that an effect of considerably reducing distortion of the drive waveforms is obtained.

While an example where the phase is divided into 32 areas has been described, the number of divisions may be increased to perform correction more finely, thereby obtaining a higher correction effect.

### Second Embodiment

In the first embodiment, the generation of the correction table for correcting the fluctuation of the drive count value due to cogging and the fluctuation correction method of the drive count value using the correction table have been described. Note that the occurrence pattern of cogging changes depending on a drive speed or a drive voltage.

Accordingly, in the second embodiment, to enable real-time correction of the drive count value, the processing of the target advance angle/power rate control unit 208 is executed as follows.

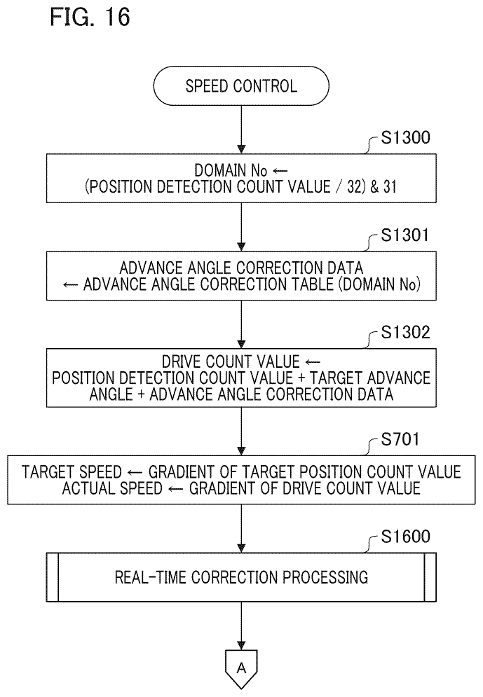

FIG. 16 is a flowchart illustrating a processing example of speed control according to a second embodiment. The operations in respective steps of the flowchart of FIG. 16 are sequentially performed by the CPU or the like serving as a computer in the motor control device executing a computer program stored in the memory.

The second embodiment is different from the first embodiment in that, as illustrated in FIG. 16, real-time correction processing of Step S1600 is added to the speed control described with reference to FIGS. 5 and 13. The flow up to Step S1600 of FIG. 16 is the same as that in FIG. 13, the flow after Step S1600 is the same as that in FIG. 14, and description of such processing will not be repeated.

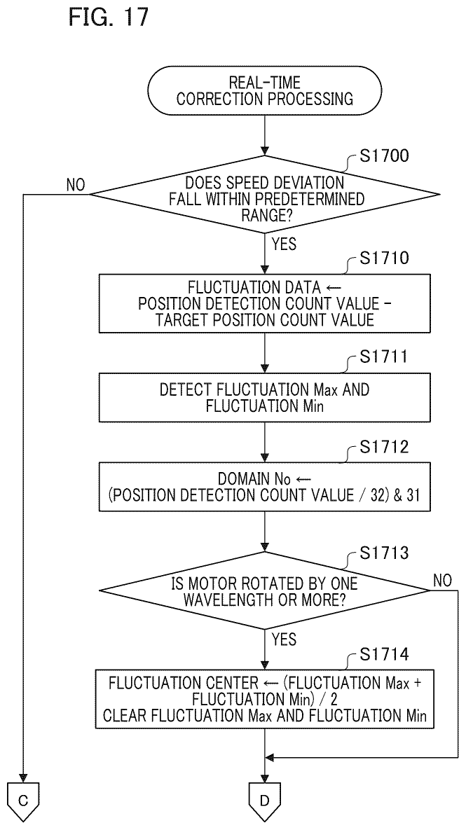

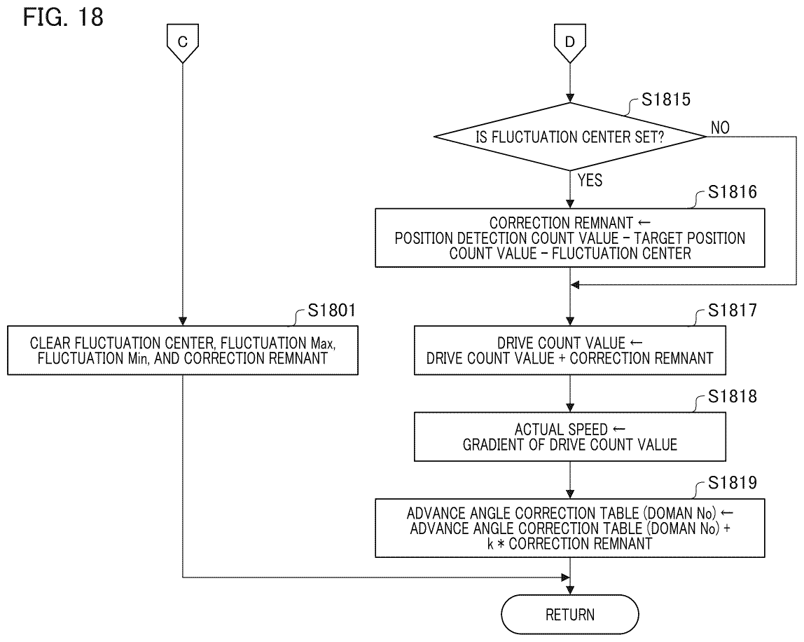

FIG. 17 is a flowchart illustrating a real-time correction processing example of Step S1600 of FIG. 16, and FIG. 18 is a flowchart subsequent to FIG. 17. The operations in respective steps of the flowcharts of FIGS. 17 and 18 are sequentially performed by the CPU or the like serving as a computer in the motor control device executing a computer program stored in the memory.

In the real-time correction processing of FIG. 17, first, in Step S1700, determination is made whether or not the deviation between the target speed and the actual speed falls within a prescribed range. If determination is made to be No in Step S1700, to prevent a pull-in operation of a speed by the speed control from being obstructed, real-time correction is not performed, in Step S1801, various kinds of operation data are cleared and the processing ends, and the process returns to Step S1700.

The “prescribed range” in Step S1700 is a value that is changed according to tuning of a servo, and may be set within a range without obstructing responsibility of speed pull-in. If determination is made to be Yes in Step S1700, the process proceeds to Step S1710, and the real-time correction processing of the drive count value is carried out.

That is, in Step S1710, as the real-time correction processing, fluctuation data is calculated. Fluctuation is fluctuation of the position detection count value, and corresponds to the difference between the position detection count value and the target position count value as described in Step S1105.

Next, in Step S1711, MAX of the fluctuation data and MIN of the fluctuation data are detected. In Step S1712, the domain No indicating the rotational phase of the motor is calculated. Similarly to Step S1300, the domain No is calculated using Expression 4 described above. In Step S1713, detection is made whether or not the motor is rotated for one wavelength or more of the Hall waveform.

This is detected with movement of 32 or more of the domain No. In Step S1713, if detection is made that the motor is rotated for one wavelength or more, in Step S1714, the fluctuation center is obtained using Expression 5 below, and after the fluctuation center is calculated, the fluctuation MAX and the fluctuation MIN detected in Step S1711 are cleared.

$$Fluctuation center = ( fluctuation MAX and fluctuation MIN ) / 2 \qquad ( 5 )$$

Next, in Step S1815 of FIG. 18, determination is made whether or not the fluctuation center is set, and if determination is made to be Yes, in Step S1816, a correction remnant is calculated. The correction remnant is data of the 0 center obtained by further subtracting the fluctuation center from the difference between the position detection count value and the target position count value.

In Step S1817, the correction remnant is added to the drive count value obtained in Step S1302 to update the drive count value. The actual speed is updated based on the gradient of the drive count value in Step S1818 in conformity with the update of the drive count value.

In Step S1819, the advance angle correction table is also updated. That is, a value obtained by multiplying table data of the domain No where the correction remnant is calculated, by a weight k is added to the advance angle correction table set in Step S1110 to update the advance angle correction table. Here, the weight k is a value that is determined according to the degree of confidence of the correction remnant.

Here, while an example where the real-time correction is performed on the correction remnant in the correction of the drive count value according to the first embodiment has been described, in the second embodiment, real-time correction is applicable to correction other than the correction of the drive count value according to the first embodiment.

In this way, in the present embodiment, with respect to the correction remnant of the target advance angle, the target advance angle is updated according to the correction data calculated during the advance angle control, and the correction data according to the rotational phase is updated based on the correction data calculated during the advance angle control.

As described above, in the second embodiment, since it is possible to correct the drive count value in real time, even when the generation pattern of cogging changes with change in drive speed or drive voltage, it is possible to cope with the correction of the drive count value.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the motor control device or the like through a network or various storage media. Then, a computer (or a CPU, an MPU, or the like) of the motor control device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-149190, filed on Sep. 14, 2023, which is hereby incorporated by reference herein in its entirety.

What is claimed is:

1. A motor control device comprising:
at least one processor or circuit configured to function as:
a target position generation unit configured to generate a target position for rotation control of a motor;
an encoding unit configured to detect a rotational phase of the motor and convert the rotational phase into rotation position information;
an advance angle control unit configured to generate a target advance angle according to a deviation amount between the target position and the rotation position information and perform advance angle control of a drive signal; and
a drive signal generation unit configured to add the target advance angle to the rotation position information to generate a drive count value and generate the drive signal based on the drive count value,
wherein the advance angle control unit is configured to
set or calculate correction data according to the rotational phase, and
correct the target advance angle based on the correction data.

2. The motor control device according to claim 1,
wherein, with respect to a correction remnant of the target advance angle,
the target advance angle is updated according to the correction data calculated during the advance angle control, and
the correction data according to the rotational phase is updated based on the correction data calculated during the advance angle control.

3. The motor control device according to claim 1, further comprising:
a magnet for phase detection attached to a rotation shaft of the motor; and
a pair of Hall sensors disposed in such a manner that sinusoidal waveforms deviated from each other by 90° are detected,
wherein the rotation position information is information regarding a rotation amount obtained by integrating the calculated rotational phase based on signals from the pair of Hall sensors according to rotation of the motor.

4. The motor control device according to claim 1,
wherein the drive signal generation unit is configured to
generate sinusoidal two-phase drive signals deviated from each other by 90° by converting angle information of the drive count value.

5. The motor control device according to claim 1,
wherein the rotation position information has periodic fluctuation according to rotation of the motor, and
the advance angle control unit is configured to
measure a fluctuation amount of the fluctuation from a difference between the target position and the rotation position information,
measure a central value of the fluctuation, and
calculate the correction data from a difference between the fluctuation amount and the central value of the fluctuation.

6. The motor control device according to claim 5,
wherein the advance angle control unit is configured to
divide a phase range for one period of the periodic fluctuation into a plurality of areas, and
set the correction data according to the rotational phase for each area.

7. The motor control device according to claim 5,
wherein the periodic fluctuation is synchronized with a phase of a two-phase signal detected from a Hall sensor.

8. The motor control device according to claim 5,
wherein the periodic fluctuation is synchronized with the rotational phase of the motor.

9. The motor control device according to claim 1, further comprising:
a moving member configured to move according to rotation of the motor,
wherein the advance angle control unit is configured to
drive the motor to search for a coordinate origin of a position of the moving member,
a duration of initialization drive during which the target position and the rotation position information are initialized to prescribed values with the found position as a reference and coordinates are aligned is provided,
in the duration of the initialization drive, the advance angle control is not performed, the target position is set to the drive count value, and control is switched to perform open control, and
if the initialization drive ends, control is switched to the advance angle control.

10. The motor control device according to claim 1,
wherein the correction data is a correction table stored in a memory in advance.

11. The motor control device according to claim 1,
wherein the correction data is set at a plurality of speeds, and
if a target speed at which the correction data is not set is selected, the correction data is calculated by interpolation.

12. The motor control device according to claim 1,
wherein the correction data is set respectively according to a rotation direction of the motor.

13. The motor control device according to claim 1,
wherein the advance angle control unit has a parameter indicating a relationship between an amplitude of the drive signal and a fluctuation width, and
the correction data adjusts a correction width according to the amplitude of the drive signal.

14. The motor control device according to claim 1,
wherein the at least one processor or circuit is further configured to function as,
the advance angle control unit that includes
a target speed calculation unit configured to calculate a gradient of the target position set by the target position generation unit as a target speed, and
a detected speed calculation unit configured to calculate a gradient of the rotation position information changing according to rotation of the motor as a detected speed,
converts a deviation amount between the target position and the rotation position information into a speed deviation amount between the target speed and the detected speed, and calculates an adjustment amount of an advance angle based on the converted speed deviation amount, and
corrects the target advance angle based on the adjustment amount.

15. The motor control device according to claim 1,
wherein the at least one processor or circuit is further configured to function as the advance angle control unit that includes
a target speed calculation unit configured to calculate a gradient of the target position set in the target position generation unit as a target speed, and
a detected speed calculation unit configured to calculate a of the rotation position information changing according to rotation of the motor, and
an amplitude of the drive signal is adjusted according to a speed deviation amount between the target speed and the detected speed.

16. An optical apparatus comprising:
at least one processor or circuit configured to function as:
a motor control device including
a target position generation unit configured to generate a target position for rotation control of motor,
an encoding unit configured to detect a rotational phase of the motor and convert the rotational phase into rotation position information,
an advance angle control unit configured to generate a target advance angle according to a deviation amount between the target position and the rotation position information and perform advance angle control of a drive signal, and
a drive signal generation unit configured to add the target advance angle to the rotation position information to generate a drive count value and generate the drive signal based on the drive count value,
the advance angle control unit being configured to
set or calculate correction data according to the rotational phase, and
correct the target advance angle based on the correction data;
a motor that is subjected to rotation control by the motor control device; and
a lens that is moved by the motor.

17. A motor control method comprising:
generating a target position for rotation control of a motor;
detecting a rotational phase of the motor and converting the rotational phase into rotation position information;
generating a target advance angle according to a deviation amount between the target position and the rotation position information and performing advance angle control of a drive signal; and
superimposing the target advance angle on the rotation position information to generate a drive count value and generating the drive signal based on the drive count value,
wherein the performing of the advance angle control
sets or calculates correction data according to the rotational phase, and
corrects the target advance angle based on the correction data.

18. A non-transitory computer-readable storage medium configured to store a computer program comprising instructions for executing following processes:
generating a target position for rotation control of a motor;
detecting a rotational phase of the motor and converting the rotational phase into rotation position information;
generating a target advance angle according to a deviation amount between the target position and the rotation position information and performing advance angle control of a drive signal; and
superimposing the target advance angle on the rotation position information to generate a drive count value and generating the drive signal based on the drive count value,
wherein the performing of the advance angle control
sets or calculates correction data according to the rotational phase, and
corrects the target advance angle based on the correction data.
